(19) United States
(12) Patent Application Publication
(10) Pub. No.: US 2017/0327299 A1
(43) Pub. Date: Nov. 16, 2017

(54) ARRANGEMENT FOR PRESSING A PASTY OR FLUID SUBSTANCE OUT OF A FILM BAG

(71) Applicant: SIKA TECHNOLOGY AG, Baar (CH)

(72) Inventor: Manuel BUCK, Gebenstorf (CH)

(73) Assignee: SIKA TECHNOLOGY AG, Baar (CH)

(21) Appl. No.: 15/513,466

(22) PCT Filed: Sep. 18, 2015
(86) PCT No.: PCT/EP2015/071507

§ 371 Date: Mar. 22, 2017

(30) Foreign Application Priority Data
Sep. 23, 2014 (EP) 14186052.8

(51) Int. Cl. B65D 83/00; B05C 17/005; B05C 17/01; B05B 9/08

(52) U.S. Cl. CPC B65D 83/0072; B05C 17/00583; B05C 17/00506; B05C 17/00516; B05B 9/0838; B05C 17/00586; B05C 17/014

(57) ABSTRACT

The disclosure relates to an assembly for pressing a pasty or fluid substance out of a film bag of a substantially cylindrical basic form. The film bag is or can be accommodated in a cylindrical receptacle having a circular inner cross-section A. The film bag inserted into the cylindrical receptacle is supported at a proximal end of the cylindrical receptacle against a closing cap that closes off the cylindrical receptacle at an end of the cylindrical receptacle. Coupling devices are provided on the cylindrical receptacle and/or the closing cap, which coupling devices ensure that the inner cross-section A of the cylindrical receptacle overlaps with an inner cross-section B of the closing cap within a tolerance relative to the wall thickness W of the closing cap on the distal side of the closing cap facing the cylindrical receptacle.

### TECHNICAL FIELD

The invention relates to an arrangement for Dressing a pasty or fluid substance out of a film bag, according to the preamble of patent claim 1.

### PRIOR ART

From the prior art, film bags of substantially cylindrical basic shape, which are filled with pasty or fluid substance and which are generally closed off at the ends, for instance by clamps, and in this respect have end-rounded ends, are already known. Film bags of this type are generally pressed out by being inserted into a cylindrical receptacle which at a first end is closed off, for instance, by means of a closing cap. From a second end of the cylindrical receptacle, pressure is applied to the film bag via a pressing element, so that the substance contained therein is pressed out via an appropriate press-out opening in the closing cap. The closing cap is generally constituted by a plastic-made disposable part, which traditionally is inserted into the end of the cylindrical receptacle and is secured relative to the cylindrical receptacle by suitable fastening means.

However, the problem exists that that cross section within the cylindrical receptacle which is free for the film bag is reduced through the insertion of the closing cap by at least the wall thickness of the closing cap, or the closing cap, in the pressing-out of the pasty or fluid substance, constitutes a “step” in relation to the inner wall of the cylindrical receptacle for the film bag, with the result that the emptied bag is not always ensured to fold fully, as intended, into the receiving space formed by the closing cap. Instead it can happen that film and/or pressing element get caught on the step formed by the wall of the closing cap, or, worse still, that parts of the film are squeezed through between closing cap and inner wall of the cylindrical receptacle in the press-out direction. Removal of the closing cap with the emptied film can then be made considerably more difficult or, without the aid of suitable tools, impossible. Moreover, there is the risk of damage to the pressing element and to the sensitive sealing lips disposed thereon.

DE 10 2001 060 382 A1 describes a tubular bag applicator gun having a handle which enables the user to control and guide the gun properly. The tubular bag gun further has an elongate hollow cylinder, which serves to receive a tubular bag. For this purpose, the hollow cylinder is designed open on that side which, in relation to the side of the handle, is facing away from the tubular bag gun and can be closed off with a cap-like closure. The closure is connectable to the hollow cylinder via suitable connecting means. In D1, the closing cap is mounted from outside onto the cylindrical receptacle. Although this does not give rise to a step in the inner wall (as described above), in such a solution the film bag cannot be received in the closing cap, which makes the handling of the device more difficult (for instance when it is a matter of removing the folded-up film bag after use, together with the closing cap). In DE 10 2007 060 382 A1, this is accomplished with am annular body, onto which the folded-up film is slipped. This is perceived as comparatively complex.

U.S. Pat. No. 5,650,180 describes a device for dispensing pasty materials, in which at the transition between a cylindrical receptacle and a closing cap there is provided a widening, into which the emptied film is placed. However, this solution too relies on steps, which can lead to complications.

US 2009/0065527 A1 describes a device for dispensing liquids, in which a step is likewise provided (in this case on the inside) between closing cap and receptacle for the material (with the problems described above).

EP 1 0 65 153 A1 describes a film package for a pasty substance, having a tubular film bag, to the end face of which is fixedly attached a cover part. Due to the fixed connection between tubular film bag and cover part, the tubular film bag cannot be inserted in the direction of the cover part, which makes the handling of the device more difficult.

The present invention has set out to provide an arrangement in which a complete accommodation of the film of the emptied film bag within the receiving space of the closing cap is ensured with sufficient certainty.

This object is achieved with an arrangement according to the features of claim 1. Advantageous refinements are defined in the subclaims.

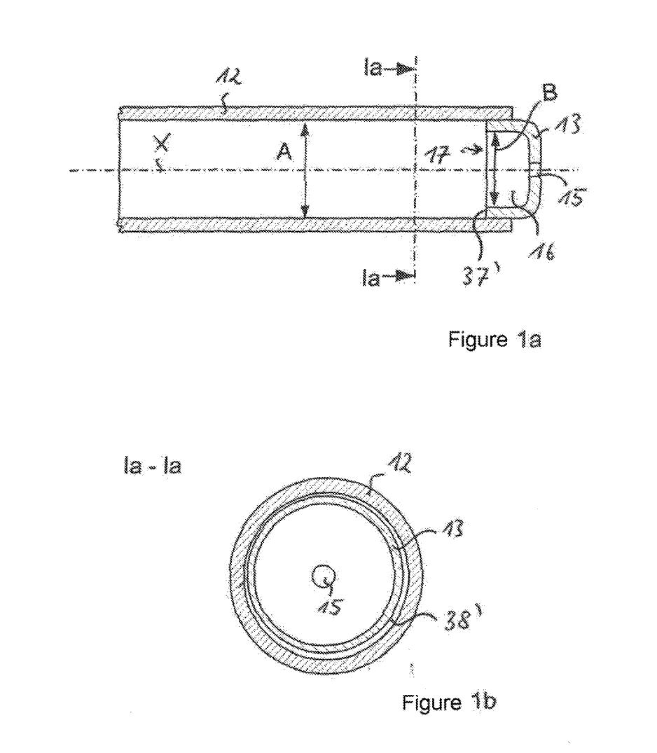

A fundamental central idea of the present invention consists in providing coupling devices, which act between the cylindrical receptacle and the closing cap and which ensure that the (entire) inner cross section A of the cylindrical receptacle and the (entire) inner cross section B of the closing cap, at its distal end facing the cylindrical receptacle, overlap (at least substantially fully). According to the invention, a deviation (tolerance) of less than 50%, preferably less than 20%, of the wall thickness of the closing cap at its distal end facing the cylindrical receptacle from the (full) overlap is also possible. The two inner cross sections A, B thus do not have to be fully in register. In the prior art (see FIGS. 1a and 1b), this deviation is equal to 100% of the wall thickness. In other words, it is in this respect ensured by the coupling devices that the projections of the inner cross section A of the cylindrical receptacle and of the inner cross section B of the closing cap at its distal end onto a plane perpendicular to the center axis X are (at least substantially) congruent, or an inner cross section A or B projects beyond the other inner cross section B or A in this projection at no point by more than 50% of the wall thickness of the closing cap at its distal end, preferably by no more than 20% of the wall thickness of the closing cap (at its distal end). A situation in which the film bag must be pressed against a step predefined by the closing cap is hereby avoided. To this extent, as a result of an incomplete overlap of the inner cross sections A, B, a (small) step remains, yet this is at no point deeper than 50% of the wall thickness of the closing cap (preferably 20% of the wall thickness of the closing cap) (wherein the depth is to be measured in the radial direction).

The cylindrical receptacle and the closing cap are preferably (fixedly) connectable to each other, for instance via integral bonding and/or force closure and/or form closure, for instance via a frictional closure and/or a tongue and groove connection and/or a screw joint and/or a bayonet fastening and/or a screw cap.

The film bag is supported against the closing cap. In particular, the film bag is essentially movable in relation to the closing cap and is not (fixedly) connected thereto. Insofar as the film bag is in contact with the closing cap, it can also be redetactable from the closing cap (without resulting in damage to film bag and/or closing cap and/or to any bonding layer which may be present).

By way of clarification, it is pointed out that the cylindrical receptacle does not necessarily have to have the basic shape of a circular cylinder, but can also be a cylinder of slightly oval basic shape, for instance. Accordingly, the inner cross section A of the cylindrical receptacle would then not be an exact circle, but rather, for instance, a slight oval. Correspondingly, the inner cross section B of the closing cap would have to be oriented to the respectively concrete inner cross section A, possibly also deviating slightly from the rotational form, of the cylindrical receptacle. For instance, it would be conceivable to reshape a circular inner cross section A or circular inner cross section B with 48 mm diameter as an oval, such that mutually perpendicular axial dimensions of 49 mm and 47 mm are given for the inner cross section A and the inner cross section B.

In a preferred refinement, the cylindrical receptacle has at its end facing the closing cap a circumferential groove or tongue, in which the closing cap is secured in the radial direction perpendicular to the center axis of the cylindrical receptacle.

This also radial securement of the closing cap is advantageous, since traditionally an exact observance of the predefined inner cross section B for the receiving space of the closing cap generally produced as a disposable plastics part cannot always be adequately ensured, and steps or gaps can also thereby be formed.

In a preferred embodiment, the closing cap is axially securable by a screw joint, a bayonet fastening or a screw cap according to the principle of a cap nut, in the direction of the center axis X relative to the cylindrical receptacle.

In a concretely possible embodiment, the cylindrical receptacle forms a groove which is open toward the inner side of the cylindrical receptacle, wherein the groove in the radial direction, viewed from the center axis X, has a width which corresponds to the width of the closing cap at its distal end. The distal end of the closing cap is in this embodiment thus inserted into the cylindrical receptacle such that the inner faces of cylindrical receptacle and closing cap are in mutual alignment.

By way of supplement or additionally, it is also possible, however, that the closing cap has a groove, in which that end of the cylindrical receptacle which is facing the closing cap engages. In a concretely possible embodiment, that end of the cylindrical receptacle which is facing the closing cap can have a circumferential tongue, which engages in the groove of the closing cap.

For the securement of the closing cap in the axial direction (parallel to the center axis X), there can be provided a screw cap, which at its end facing the cylindrical receptacle has first engagement means, which are configured correspondingly to second engagement means configured at that end of the cylindrical receptacle which is facing the closing cap. The first engagement means configured on the screw cap can be constituted, for instance, by an internal thread which is screwable onto a corresponding external thread provided on the outer side of the cylindrical receptacle. Instead of a thread, a bayonet fastening, for instance, would also be conceivable however.

In a preferred refinement, the screw cap can have alignment devices, which ensure an alignment of a preferred axis of the screw cap collinearly to the central center axis X of the cylindrical receptacle. Ideally, the proposed screw cap effects in this respect a securement of the closing cap both in the axial direction parallel to the longitudinal axis X and in the radial direction, i.e. perpendicular to the longitudinal axis X.

In a further preferred embodiment, the closing cap has a press-out nozzle, which in particular is integrally molded on. In this case, the alignment devices of the screw cap can comprise, for instance, contact elements, which embrace the press-out nozzle from the outside and thus secure the closing cap in the desired alignment.

In a concretely possible embodiment, the arrangement further comprises a transmission unit for the connection of an, in particular, electric drive, in order to the pressing element in the direction of the closing cap.

In a further possible embodiment, in addition to the cylindrical receptacle for receiving a film bag, there is further provided at least one cartridge receiving device for receiving an exchangeable cartridge containing a second pasty or fluid substance, and a mixing device for mixing the two substances, wherein the transmission unit is configured and designed to effect via appropriately provided drive elements a simultaneous pressing of the substance out of the film bag and of the substance out of the cartridge receiving device, with subsequent mixing of the two substances.

### REPRESENTATION OF THE INVENTION

The invention is explained also with regard to further features and advantages in greater detail below, on the basis of the description of illustrative: embodiments and with reference to the following drawings, in which:

FIGS. 1a and 1b show the starting problems for the present invention in the prior art;

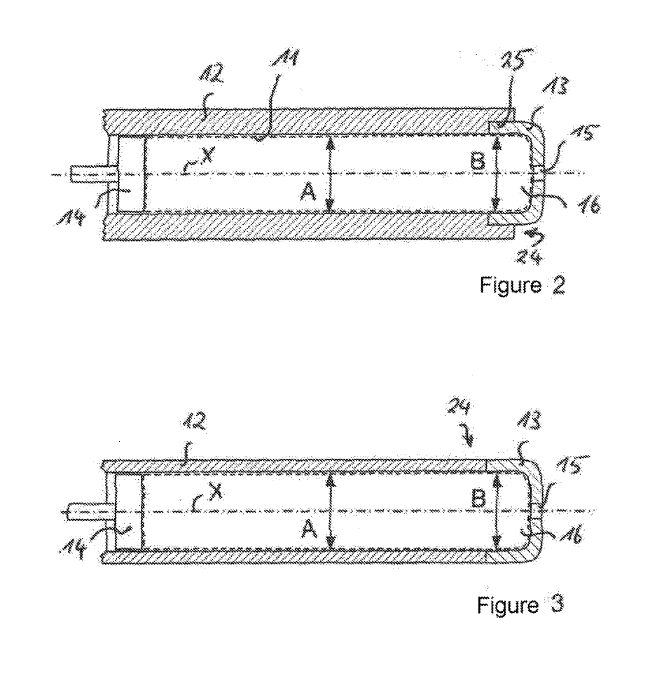

FIG. 2 shows a first possible embodiment of an arrangement according to the present invention;

FIG. 3 shows a second possible embodiment of an arrangement according to the present invention;

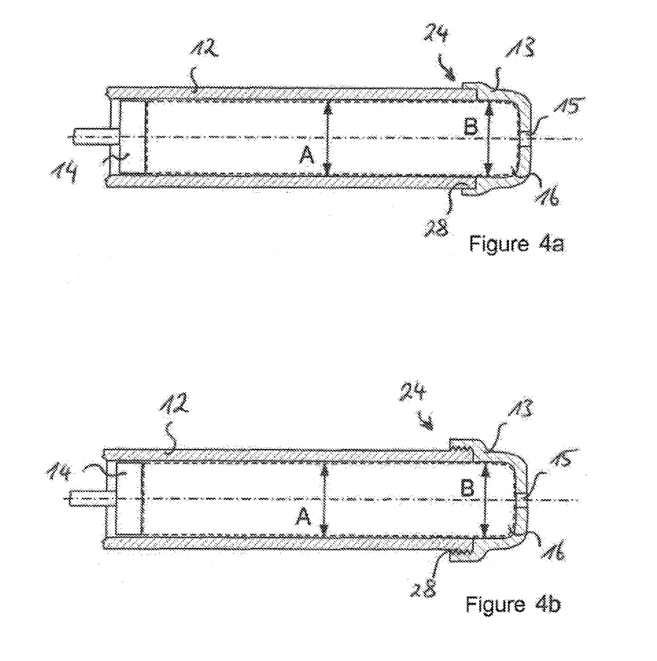

FIG. 4a shows a third possible embodiment of an arrangement according to the present invention;

FIG. 4b shows a modification of the third possible embodiment of an arrangement according to the present invention;

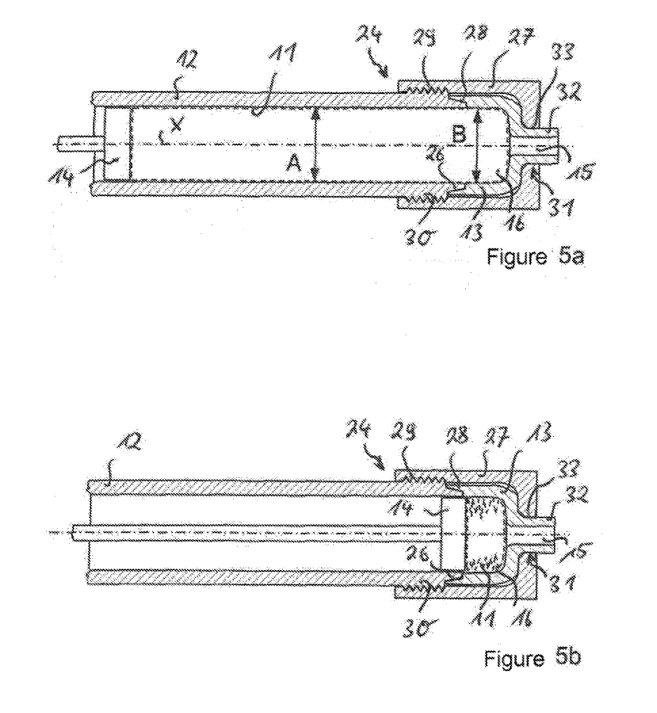

FIGS. 5a and 5b show a fourth embodiment of an arrangement according to the present invention with filled film bag (FIG. 5a) and pressed-out film bag (FIG. 5b);

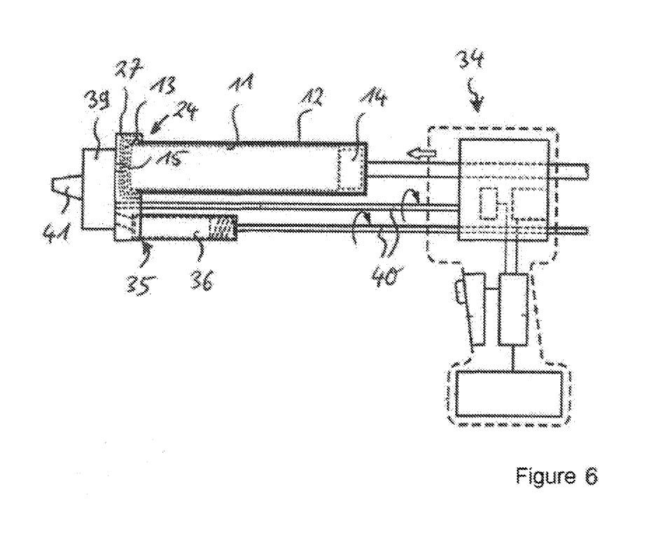

FIG. 6 shows an embodiment of a refinement of the present invention in a schematic view.

In FIGS. 1a and b, the starting problems for the present invention are illustrated on the basis of the prior art. In a cylindrical receptacle 12, a film bag 11 can be received. At a proximal end 24, the cylindrical receptacle 12 is closed off by a closing cap 13, which has a press-out opening 15. By means of a pressing element 14 (cf. FIGS. 2 to 6), a film bag 11 inserted in the cylindrical receptacle 12 (cf. FIGS. 2 to 6) can be acted upon in the direction of the closing cap 13 and in this way the substance accommodated in the film bag 11 can be pressed out through the press-out opening 15.

Since the closing cap 13 is inserted in the cylindrical receptacle 12, in the prior art the inner cross section B of a receiving space 16 of the closing cap 13 is smaller, at least by twice the wall thickness of the closing cap 13 at its distal end, than the inner cross section A of the cylindrical receptacle. Hence, for the film of the film bag 11, a step 37′ is created when, in the emptying operation, the remaining film of the film bag is pressed into the receiving space 16 of the closing cap 13.

An additional problem is created by the fact that, due to tolerances and/or deviations from an exact circular form, the closing cap 13 has a cross section which, in relation to the inner cross section of the cylindrical receptacle 12, allows one or more gaps 38′. In the pressing-out of the film bag, a part of the film can therefore be pressed into such a gap 38′, with the result that the closing cap 13 can subsequently no longer be removed, at any rate no longer without the use of tools, from the cylindrical receptacle 12. Moreover, there is the risk that, in the event of an improper transfer of the emptied film into the receiving space 16 of the closing cap 13, damage can occur to the pressing ram, above all to the sealing lips disposed on the periphery of the pressing ram.

The embodiments according to FIGS. 2 to 6 show by way of example now the portrayed problems can be remedied. Of critical importance is that it is ensured by coupling devices that the closing cap is applied to the cylindrical receptacle such that the inner cross section A of the cylindrical receptacle 12 is substantially congruent with the inner cross section B of the closing cap 13, i.e. inner cross section A and inner cross section B overlap everywhere or at no point is more than 50% of the wall thickness W of the closing cap offset on its distal side facing the cylindrical receptacle. The coupling devices which ensure an exactest possible overlap of the inner cross section A of the cylindrical receptacle 12 with the inner cross section B of the closing cap 13 can he differently configured. To this end, a plurality of embodiments are described below by way of example.

In a first embodiment, which is illustrated in FIG. 2, the coupling devices are formed by a groove 25 provided at the proximal end 24 of the cylindrical receptacle 12. The cylindrical receptacle thus has at its proximal end 24 a groove 25 which is open toward the inner side of the cylindrical receptacle. The groove 25 here has in a radial direction viewed from the center axis X a width which corresponds to the width of the closing cap 13 at its distal end facing the cylindrical receptacle. As a result of this measure an arrangement in which the inner wall of the cylindrical receptacle merges flushly into the inner wall of the closing cap 13 is created, with the result that the problems of pressing the film into a gap, or the surmounting of a step, are no longer given. The closing cap 13 can be fastened in a suitable manner in the axial direction relative to the cylindrical receptacle; for instance, the closing cap 13 can have an external thread and the groove a corresponding internal thread. However, it is also possible to insert the closing cap 13 into the groove 25 of the cylindrical receptacle via a connection in the style of a bayonet fastening. Finally, it would also be conceivable (cf. in this context the embodiments according to FIGS. 5a and 5b) to fasten the closing cap 13 to the cylindrical receptacle via a screw cap 27.

In FIG. 3 is represented a further embodiment, in which a closing cap 13 is joined at the end to the proximal end 24 of the cylindrical receptacle 12, to be precise here too such that the inner cross section A of the cylindrical receptacle 12 merges flushly into the inner cross section B of the closing cap 13. Here too, various fastening options are conceivable in order to secure the closing cap 13 in the axial direction parallel to the center axis X; in this respect, the coupling devices can here be realized, for instance, by a screw cap 27 or by a flange mounting which can be provided (not shown) on the cylindrical receptacle 12 and the closing cap 13.

In FIG. 4a, a further embodiment of the arrangement according to the invention is represented. In this arrangement, the coupling devices are realized by the closing cap 13 having a groove 28, which in the present embodiment is open in the direction of the center axis X. The proximal end 24 of the cylindrical receptacle 12 is embraced by the groove 28 of the closing cap 13, so that the closing cap 13 is secured in directions perpendicular to the center axis X and, at the same time, an adaptation to the inner cross section A of the cylindrical receptacle 12 at its proximal end 24 is ensured. In the embodiment according to FIG. 4a, the closing cap 13 can be fastened to the cylindrical receptacle 12 in a suitable manner, for instance by means of a screw cap 27 (not shown here).

In FIG. 4b, a modified embodiment of the arrangement according to FIG. 4a is represented. In this embodiment, the closing cap 13 is screwed onto the proximal end of the cylindrical receptacle 12 via a screw joint, wherein, for this purpose, the closing cap 13 has an internal thread, which is formed in the groove 28 and which cooperates with a corresponding external thread at the proximal end 24 of the cylindrical receptacle 12. Specifically in this embodiment (but also in the other embodiments described in the present case), the closing cap 13 can also, however, be desirably designed as a disposable part.

In FIGS. 5a and 5b is illustrated a further illustrative embodiment, in which the coupling devices are realized by the closing cap 13 having a groove 28 which is open toward the center axis X of the cylindrical receptacle 12, wherein that groove wall which is facing away from the center axis X is configured such that it runs obliquely, i.e. opens toward the distal end of the closing cap 13, and on the cylindrical receptacle 1 a circumferential tongue 26 is configured on the end of the proximal end of the cylindrical receptacle 12. Hence, when the closing cap 13 is mounted onto the circumferential tongue 26 with oblique flank, a self-centering of the closing cap 13 takes place.

The closing cap 13 is fastened to the cylindrical receptacle via a screw cap 27. For this purpose, the screw cap 27 has at its end facing the cylindrical receptacle 12 first engagement means 29, which are configured correspondingly to second engagement means 30 configured at that end of the cylindrical receptacle 12 which is facing the closing cap 13. In the concrete case, the first engagement means 29 on the screw cap 27 are constituted by an internal thread and the second engagement means 30 on the cylindrical receptacle are constituted by a correspondingly configured external thread.

In addition, in the present embodiment the closing cap 13 further has alignment devices 31, which are concretely formed by contact elements 33. Said contact elements 33 are supported against a press-out nozzle 32 integrally molded onto the closing cap 13 and ensure, furthermore, that the preferential direction of the closing cap 13 is aligned collinearly with the center axis X of the cylindrical receptacle 12.

In FIG. 6, a particularly preferred embodiment of the arrangement according to the invention is illustrated. In addition to the cylindrical receptacle 12, this arrangement further has a cartridge receiving device 35 for receiving an exchangeable cartridge 36, and a mixing device 39 for mixing the first pasty or fluid substance from the film bag 11 with the second pasty or fluid substance from the exchangeable cartridge 36.

Via a transmission unit 34 and appropriately provided drive elements 40, the arrangement is made such that, in a mutually coordinated manner, the pasty or fluid substance is pressed out of the film bag 11 simultaneously with a pressing of the pasty or fluid substance out of the exchangeable cartridge 36, wherein both substances, before being dispensed through a dispensing nozzle 41, are mixed together in the mixing device 39 configured as a mixer.

### REFERENCE SYMBOL LIST

11 film bag
12 (cylindrical) receptacle
13 closing cap
14 pressing element
15 press-out opening
16 receiving space
17 receiving opening
24 proximal end
25 groove (cylindrical receptacle)
26 tongue (cylindrical receptacle)
27 screw cap
28 groove (closing cap)
29 first engagement means
30 second engagement means
31 alignment devices
32 press-out nozzle
33 contact elements
34 transmission unit
35 cartridge receiving device
36 exchangeable cartridge
37′ step
38′ gap
39 mixing device
40 drive elements
41 dispensing nozzle

1. An arrangement for pressing a pasty or fluid substance out of a film bag of substantially cylindrical basic shape, the arrangement comprising:
a cylindrical receptacle having a circular inner cross section A, wherein the film bag when introduced into the cylindrical receptacle will be supported at a proximal end of the cylindrical receptacle against a closing cap which closes off the cylindrical receptacle at an end, such that a side of the film bag facing away from the closing cap will be acted upon with a pressing element in order to press out pasty or fluid substance via a press-out opening in the closing cap, wherein the closing cap has a receiving space for receiving the film during or after the pressing-out of the film bag, the receiving space having an at least substantially rotationally symmetric basic shape with a receiving opening facing the cylindrical receptacle, which receiving opening has a circular inner cross section B; and
on the cylindrical receptacle and/or the closing cap are provided coupling devices, which ensure that the inner cross section A of the cylindrical receptacle overlaps with the inner cross section B within a tolerance of less than 50% of a wall thickness W of the closing cap on its distal side facing the cylindrical receptacle.

2. The arrangement as claimed in claim 1, wherein the cylindrical receptacle comprises:
at its end facing the closing cap a circumferential groove or tongue, in which the closing cap is secured in a radial direction perpendicular to a center axis X of the cylindrical receptacle.

3. The arrangement as claimed in claim 2, wherein the closing cap is axially securable by a screw joint, a bayonet fastening or a screw cap according to the principle of a cap nut, in a direction of the center axis X.

4. The arrangement as claimed in claim 3, wherein the cylindrical receptacle forms a groove which is open toward the inner side of the cylindrical receptacle, wherein the groove in a radial direction, viewed from the center axis X, has a width which corresponds to the width of the closing cap at its distal end.

5. The arrangement as claimed in claim 1, wherein the closing cap comprises:
a groove, for engaging that end of the cylindrical receptacle which is facing the closing cap.

6. The arrangement as claimed in claim 5, wherein that end of the cylindrical receptacle which is facing the closing cap has a circumferential tongue for engaging in the groove of the closing cap.

7. The arrangement as claimed in claim 1, comprising:
a screw cap, which at its end facing the cylindrical receptacle has first engagement means configured correspondingly to second engagement means configured at that end of the cylindrical receptacle which is facing the closing cap, wherein, in a fitted state, the screw cap nut secures the closing cap in the axial direction.

8. The arrangement as claimed in claim 7, wherein the screw cap comprises:
alignment devices, which ensure an alignment of a preferred axis of the screw cap collinearly to a central longitudinal axis X of the cylindrical receptacle.

9. The arrangement as claimed in claim 8, wherein the closing cap comprises:
an integrally molded press-out nozzle and alignment devices of the screw cap are being formed by contact elements, which embrace the press-out nozzle from the outside.

10. The arrangement as claimed in claim 9, comprising:
a transmission unit for the connection of an electric drive to act upon the pressing element in a direction of the closing cap.

11. The arrangement as claimed in claim 1, comprising:
in addition to the cylindrical receptacle for receiving the film bag, at least one cartridge receiving device for receiving an exchangeable cartridge in which a second pasty or fluid substance is accommodated; and
a mixing device for mixing a first pasty or fluid substance from a film bag with a second pasty or fluid substance from an exchangeable cartridge, wherein the transmission unit is configured to effect, via appropriate drive elements, in a mutually coordinated manner, a simultaneous pressing of the pasty or fluid substance out of the film bag with a pressing of the pasty or fluid substance out of the exchangeable cartridge and subsequent mixing of the two substances.

12. The arrangement as claims in claim 1, wherein the tolerance is less than 20% of the wall thickness of the closing cap on its distal side facing the cylindrical receptacle.

13. The arrangement as claimed in 11, comprising, in combination:
a film bag with a first pasty or fluid substance; and
an exchangeable cartridge with a second pasty or fluid substance.

14. The arrangement as claimed in claim 4, wherein the closing cap comprises:
a groove, for engaging that end of the cylindrical receptacle which is facing the closing cap.

15. The arrangement as claimed in claim 14, comprising:
a screw cap, which at its end facing the cylindrical receptacle has first engagement means configured correspondingly to second engagement means configured at that end of the cylindrical receptacle which is facing the closing cap, wherein, in a fitted state, the screw cap nut secures the closing cap in the axial direction.

16. The arrangement as claimed in claim 15, comprising:
in addition to the cylindrical receptacle for receiving the film bag at least one cartridge receiving device for receiving an exchangeable cartridge in which a second pasty or fluid substance is accommodated; and
a mixing device for mixing a first pasty or fluid substance from a film bag with a second pasty or fluid substance from an exchangeable cartridge, wherein the transmission unit is configured to effect, via appropriate drive elements, in a mutually coordinated manner, a simultaneous pressing of the pasty or fluid substance out of the film bag with a pressing of the pasty or fluid substance out of the exchangeable cartridge and subsequent mixing of the two substances.

17. The arrangement as claimed in 16, comprising, in combination:
a film bag with a first pasty or fluid substance; and
an exchangeable cartridge with a second pasty or fluid substance.
